(19) United States
(12) Patent Application Publication
(10) Pub. No.: US 2026/0229738 A1
(43) Pub. Date: Aug. 6, 2026

(54) FUSE UNIT AND CONDUCTIVE MODULE

(71) Applicant: YAZAKI CORPORATION, Tokyo (JP)

(72) Inventors: Yasuhiro Kominato, Makinohara-shi (JP); Katsunori Sato, Makinohara-shi (JP); Mariko Nakagawa, Makinohara-shi (JP); Miho Suzuki, Makinohara-shi (JP); Kota Morishige, Makinohara-shi (JP)

(21) Appl. No.: 19/529,139

(22) Filed: Feb. 4, 2026

(30) Foreign Application Priority Data
Feb. 5, 2025 (JP) 2025-017304

(51) Int. Cl. H01M 50/583; H01R 13/504; H01R 13/696

(52) U.S. Cl. CPC H01M 50/583; H01R 13/504; H01R 13/696

(57) ABSTRACT

A fuse unit includes a chip fuse including a first electrode, a second electrode, and a fusible portion; a first terminal fitting connected to the first electrode; a second terminal fitting connected to the second electrode; a resin member that holds the first terminal fitting and the second terminal fitting, wherein a plurality of first recesses are formed on the first terminal fitting, a plurality of second recesses are formed on the second terminal fitting, a plurality of first protrusions and a plurality of second protrusions are formed on the resin member, and it is configured that the plurality of first recesses and the plurality of first protrusions are respectively fitted, and the plurality of second recesses and the plurality of second protrusions are respectively fitted.

### CROSS-REFERENCE TO RELATED APPLICATIONS

The present application claims priority to and incorporates by reference the entire contents of Japanese Patent Application No. 2025-017304 filed in Japan on February 5, 2025.

### BACKGROUND OF THE INVENTION

### 1. Field of the Invention

The present invention relates to a fuse unit and a conductive module.

### 2. Description of the Related Art

The conductive module is a battery module in which a plurality of battery cells are arranged, and electrically connects the plurality of battery cells using a plurality of connection conductors. Then, the conductive module electrically connects each connection conductor to a battery monitoring unit that monitors a battery state of the battery cell using a wiring component such as an electric wire. For example, JP 2020 – 119651 A discloses this type of conductive module. In such a conductive module, a combination of a connection conductor and a conductor portion of the wiring component is provided for each connection conductor, and a circuit protection component such as a fuse may be interposed between the connection conductor and the conductor portion of the wiring component in each combination. For example, JP 7 561 318 B2 discloses a fuse unit (composed of a chip fuse, a pair of terminal fittings, and a resin member) applied to the conductive module.

In the conventional fuse unit, a chip fuse is connected to a pair of terminal fittings in which a resin member is insert-molded. However, there is room for improvement in bonding strength between the resin member and the terminal fittings. For example, when bonding strength between the resin member and the terminal fitting is low, it is likely that the connection between the terminal fitting and the chip fuse becomes unstable. For this reason, it is desired to develop a technique for increasing the bonding strength between the resin member and the terminal fitting.

### SUMMARY OF THE INVENTION

Therefore, an object of the present invention is to provide a fuse unit and a conductive module capable of increasing bonding strength between a resin member and a terminal fitting.

In order to achieve the above mentioned object, a fuse unit according to one aspect of the present invention includes a chip fuse including a first electrode, a second electrode, and a fusible portion that is fused by overcurrent; a first terminal fitting having a plate shape and being connected to a connection target and to the first electrode; a second terminal fitting having a plate shape and connected to the second electrode; and a resin member that holds the first terminal fitting and the second terminal fitting and maintains an interval between the first terminal fitting and the second terminal fitting, wherein either of a plurality of recesses or a plurality of protrusions are formed on the first terminal fitting and the second terminal fitting, the other of the plurality of recesses or the plurality of protrusions are formed on the resin member, and the plurality of recesses and the plurality of protrusions are respectively fitted.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a fuse unit and a conductive module according to an embodiment;

FIG. 2 is a schematic view illustrating a battery module together with a bus bar;

FIG. 3 is a perspective view illustrating the fuse unit according to the embodiment;

FIG. 4 is an exploded perspective view illustrating the fuse unit according to the embodiment;

FIG. 5 is an exploded perspective view illustrating the fuse unit according to the embodiment;

FIG. 6 is an explanatory diagram illustrating a modified example of the fuse unit according to the embodiment;

FIG. 7 is an exploded perspective view illustrating a modified example of the fuse unit according to the embodiment; and

FIG. 8 is an exploded perspective view illustrating a modified example of the fuse unit according to the embodiment.

### DETAILED DESCRIPTION OF THE PREFERRED EMBODIMENTS

Hereinafter, an embodiment according to the present invention will be described in detail with reference to the drawings. Note that the present invention is not limited to this embodiment. Additionally, components in the following embodiments include those that can be easily replaced by those skilled in the art or those that are substantially the same.

### Embodiment

The present embodiment relates to a fuse unit and a conductive module. In the following description, among a first direction, a second direction, and a third direction, which are intersecting each other, the first direction is referred to as a "connection direction X", the second direction is referred to as a "width direction Y", and the third direction is referred to as a "height direction Z". Here, the connection direction X, the width direction Y, and the height direction Z are orthogonal to each other. The term "orthogonal" as used herein includes substantially orthogonal. The connection direction X corresponds to a direction in which the fuse unit is connected to a connection target. Furthermore, each direction used in the following description represents a direction in a state in which each part is assembled to each other unless otherwise specified.

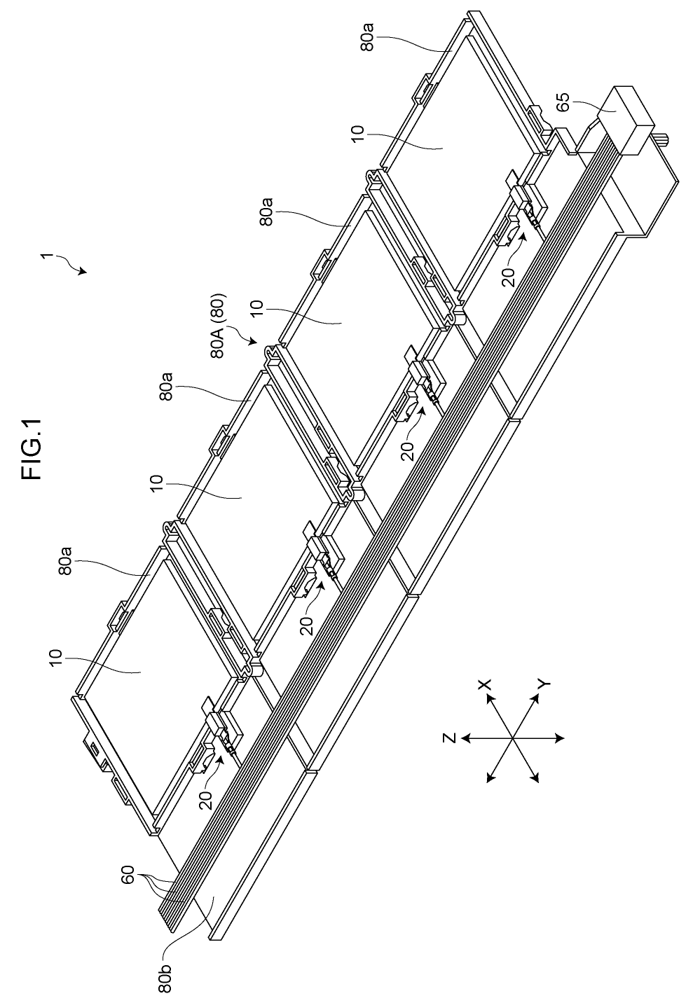

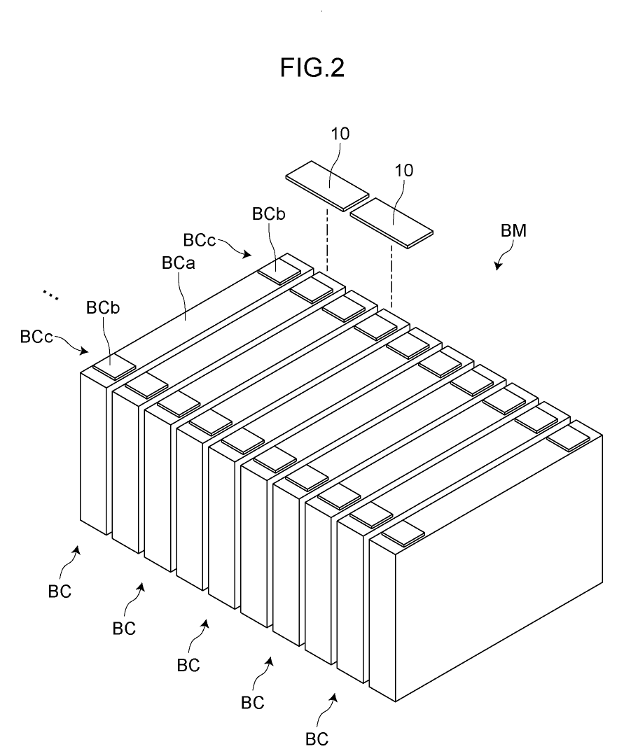

As illustrated in FIGS. 1 and 2, a conductive module 1 is assembled to a battery module BM in which a plurality of battery cells BC are arranged, and the plurality of battery cells BC in the battery module BM are electrically connected. The conductive module 1 electrically connects the battery module BM to a battery monitoring unit (not illustrated) to cause the battery monitoring unit to monitor a battery state of the battery cell BC. The conductive module 1 constitutes a battery pack together with the battery module BM. The battery pack is mounted on, for example, a vehicle (BEV: battery electric vehicle, HEV: hybrid electric vehicle, etc.) including a rotary machine as a drive source, and is used for power supply to the rotary machine.

The battery cell BC includes a cell body BCa and positive and negative electrode terminals BCb. In the battery module BM, a plurality of the battery cells BC are arranged in a row along an arrangement direction. The battery module BM includes one electrode terminal group BCc in which one electrode terminal BCb of the plurality of battery cells BC are arranged along the arrangement direction, and the other electrode terminal group BCc in which the other electrode terminals BCb of the plurality of battery cells BC are arranged along the arrangement direction.

In the battery cell BC illustrated here, the cell body BCa is formed in a rectangular parallelepiped shape having six outer wall surfaces. In the plurality of battery cells BC, the cell bodies BCa adjacent to each other in the arrangement direction are arranged such that one of outer wall surfaces in one cell body faces outer wall surfaces in the other cell bodies. For example, in the battery cell BC, the positive and negative electrode terminals BCb are arranged in one of the six outer wall surfaces of the cell body BCa or in two of the six outer wall surfaces of the cell body BCa. In this example, each battery cell BC includes the positive and negative electrode terminals BCb on one of the six outer wall surfaces of the cell body BCa. Therefore, in the battery module BM, two electrode terminal groups BCc are provided on one plane.

The electrode terminal BCb illustrated here is formed in a flat plate shape, and a connection conductor 10 to be described later is electrically connected directly by laser welding or the like. However, the electrode terminal BCb may be formed in a pole shape having a male screw portion. In this case, the connection conductor 10 is screwed and fixed to the electrode terminal BCb by screwing a female screw member to the male screw portion of the electrode terminal BCb.

The conductive module 1 includes the connection conductor 10 that is electrically connected directly to the electrode terminal BCb of the battery cell BC constituting the battery module BM.

The connection conductor 10 is formed of a conductive material such as metal. The connection conductor 10 is a plate-like conductive component made of metal, which is called a bus bar, and is press-molded using a metal plate as a base material, for example. The connection conductor 10 illustrated here is formed in a rectangular flat plate shape.

The conductive module 1 includes, as the connection conductor 10, for example, one that is electrically connected directly to the electrode terminal BCb adjacent to the pair of battery cells BC in the battery module BM, one that is electrically connected directly to the electrode terminal BCb serving as the total negative electrode in the battery module BM, and one that is electrically connected directly to the electrode terminal BCb serving as the total positive electrode in the battery module BM.

The conductive module 1 includes the connection conductor 10 and a fuse unit 20. The fuse unit 20 is connected between the connection conductor 10 and the battery monitoring unit. The fuse unit 20 indirectly and electrically connects the connection conductor 10 and the battery monitoring unit, and interrupts energization when an overcurrent flows therebetween. The fuse unit 20 is provided for each connection conductor 10.

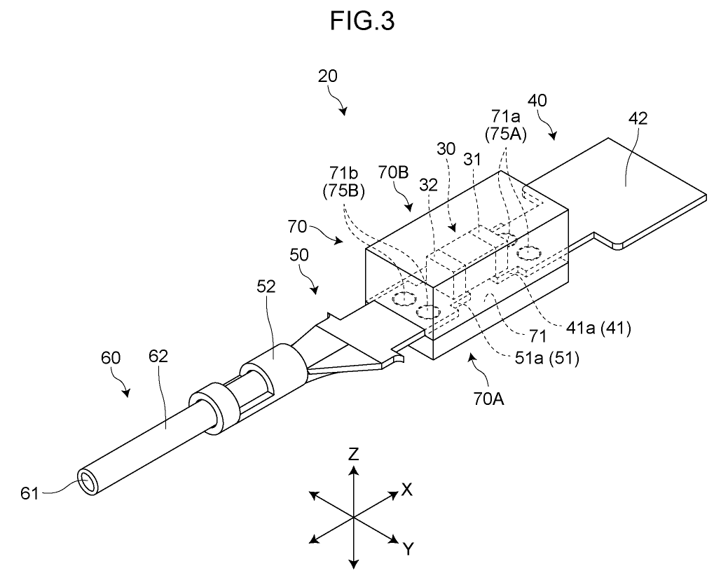

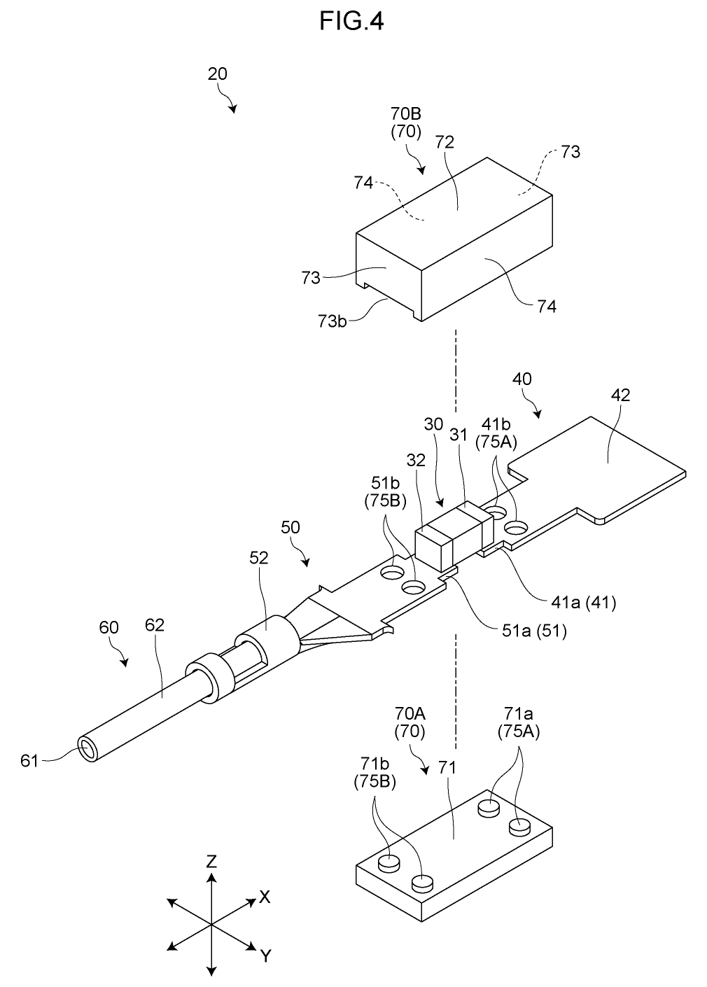

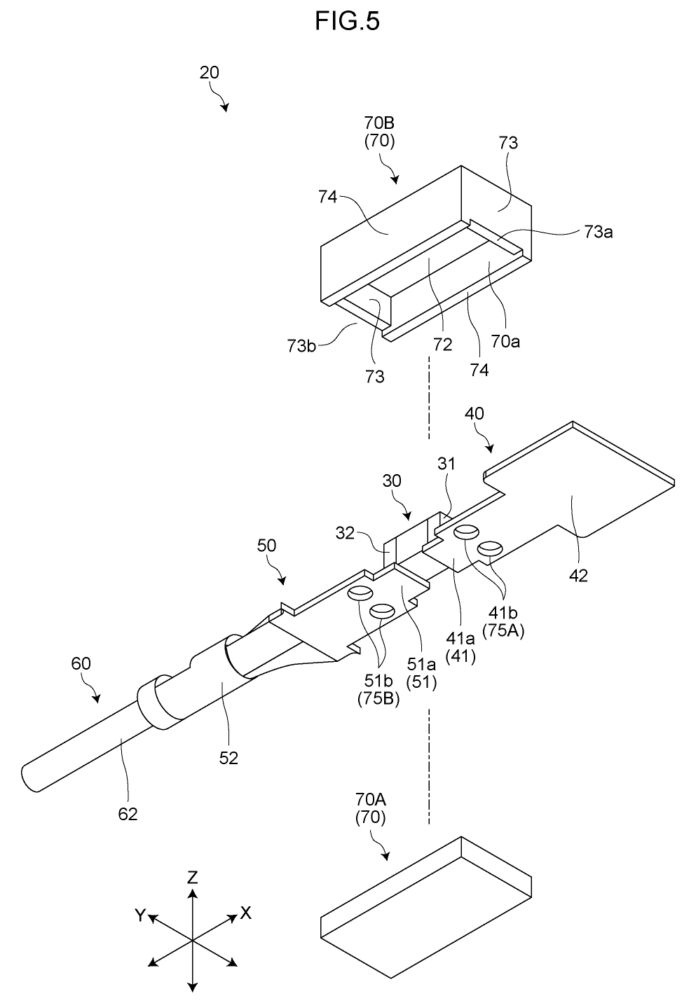

As illustrated in FIGS. 3 to 5, the fuse unit 20 includes a chip fuse 30, a first terminal fitting 40, a second terminal fitting 50, and a resin member 70. The chip fuse 30 is a circuit protection component that fuses a fusible portion when an overcurrent flows between the connection conductor 10 and the battery monitoring unit. The chip fuse 30 is configured by arranging the fusible portion between a first electrode 31 and a second electrode 32. The first electrode 31 and the second electrode 32 are arranged on a straight line, respectively at one end and the other end of the chip fuse 30.

The chip fuse 30 is configured as, for example, a surface-mountable chip component having a fusible portion, and may be configured as a pattern fuse in which a wiring pattern having a fusible portion is provided on a printed circuit board (for example, a flexible printed circuit board). The chip fuse 30 illustrated here is configured as a block-shaped chip component. The first electrode 31 is provided over five outer wall surfaces at the one end of the chip fuse 30. The second electrode 32 is provided over five outer wall surfaces at the other end of the chip fuse 30.

The fuse unit 20 includes the first terminal fitting 40 and the second terminal fitting 50 which are electrically connected directly to the chip fuse 30. The first terminal fitting 40 and the second terminal fitting 50 are formed of a conductive material such as metal. For example, the first terminal fitting 40 and the second terminal fitting 50 have a plate shape, and are formed by press molding using, for example, a metal plate as a base material.

The first terminal fitting 40 has a first electrical connection portion 41 that is directly and electrically connected to the first electrode 31 of the chip fuse 30. One of four outer wall surfaces of the first electrode 31 arranged in a circumferential direction is placed on the first electrical connection portion 41, and the first electrode 31 is directly and electrically connected by laser welding, soldering, or the like. Therefore, the first electrical connection portion 41 is formed in a flat plate shape provided with a flat surface on which the outer wall surface of the first electrode 31 is placed. The first electrical connection portion 41 illustrated here is formed in a convex flat plate shape, and the outer wall surface of the first electrode 31 is placed on this convex narrow portion. In the first electrical connection portion 41, the narrow portion serves as a contact portion 41a with the first electrode 31, and the contact portion 41a and the first electrode 31 are directly and electrically connected.

Further, the first terminal fitting 40 includes a conductor connection portion 42 which is electrically connected to the connection conductor 10 directly or indirectly. The conductor connection portion 42 is formed in a flat plate shape, and is placed on the connection conductor 10 with flat surfaces overlapping each other. The conductor connection portion 42 is directly and electrically connected to the connection conductor 10 by laser welding, ultrasonic bonding, or the like. The conductor connection portion 42 illustrated here is formed in a rectangular flat plate shape. The connection conductor 10 is a connection target to be connected to the first terminal fitting 40.

The first terminal fitting 40 illustrated here is formed in a single flat plate shape in which the first electrical connection portion 41 and the conductor connection portion 42 are adjacent to each other.

The second terminal fitting 50 has a second electrical connection portion 51 that is directly and electrically connected to the second electrode 32 of the chip fuse 30. One of four outer wall surfaces of the second electrode 32 arranged in a circumferential direction is placed on the second electrical connection portion 51, and the second electrode 32 is directly and electrically connected by laser welding, soldering, or the like. Therefore, the second electrical connection portion 51 is formed in a flat plate shape provided with a flat surface on which the outer wall surface of the second electrode 32 is placed. The second electrical connection portion 51 illustrated here is formed in a convex flat plate shape, and the outer wall surface of the second electrode 32 is placed on this convex narrow portion. In the second electrical connection portion 51, the narrow portion serves as a contact portion 51a with the second electrode 32, and the contact portion 51a and the second electrode 32 are directly and electrically connected.

Further, the second terminal fitting 50 is indirectly and electrically connected to the battery monitoring unit. The fuse unit 20 includes a wiring component 60 interposed between the second terminal fitting 50 and the battery monitoring unit, and indirectly and electrically connects the second terminal fitting 50 to the battery monitoring unit via the wiring component 60. The second terminal fitting 50 has a wiring connection portion 52 that is directly electrically connected to the wiring component 60.

The wiring component 60 includes a conductor portion 61 having one end electrically connected directly to the second terminal fitting 50 and the other end electrically connected directly or indirectly to the battery monitoring unit. The wiring component 60 includes an electrically insulating sheath 62 that covers the battery monitoring unit side from at least one end of the conductor portion 61 at the end. The wiring component 60 described here is a linear conductor having a conductor portion 61 formed in a linear shape. Specifically, the wiring component 60 is an electric wire in which a core wire as the conductor portion 61 is covered with the electrically insulating sheath 62, and electrically connects the wiring connection portion 52 directly to one end of the conductor portion 61 at the end thereof.

For example, in the wiring component 60, the insulating sheath 62 is peeled off at the terminal to expose one end of the conductor portion 61. In this case, as the wiring connection portion 52, a portion formed as a caulking crimp portion to be caulked and crimped to one end (that is, the core wire of the end of the electric wire) of the conductor portion 61 may be applied. Further, for example, as the wiring component 60, one in which one end of the conductor portion 61 is covered with the insulating sheath 62 at the end thereof may be used. In this case, as the wiring connection portion 52, one formed as a pair of pressure contact blades that makes a cut in the insulating sheath 62 at the end of the wiring component 60 and sandwiches one end of the conductor portion 61 (the core wire of the end of the electric wire) may be applied. The wiring connection portion 52 illustrated here is formed as a caulking crimp portion.

In the second terminal fitting 50 illustrated here, the second electrical connection portion 51 and the wiring connection portion 52 are adjacent to each other. The wiring connection portion 52 causes the wiring component 60 to be drawn out in a direction adjacent thereto and along the second electrical connection portion 51.

Note that the wiring component 60 may be a flat wiring member such as a flexible printed circuit board in which the conductor portion 61 is formed as a wiring pattern. In this case, in the wiring component 60, the conductor portion 61 for each of the second terminal fittings 50 in the plurality of fuse units 20 is formed, and one end of the conductor portion 61 is provided at the end of a branch portion branched from the main body for each of the second terminal fittings 50. One end of the conductor portion 61 is directly and electrically connected to the wiring connection portion 52 by, for example, laser welding, soldering, or the like.

In the fuse unit 20, the first electrical connection portion 41 of the first terminal fitting 40 and the second electrical connection portion 51 of the second terminal fitting 50 are arranged on the same flat surface at a predetermined interval. The predetermined interval is an interval (in other words, inter-electrode pitch) between the first electrode 31 and the second electrode 32 in the chip fuse 30. Therefore, the first terminal fitting 40 and the second terminal fitting 50 are arranged such that the interval between the first electrical connection portion 41 and the second electrical connection portion 51 is matched with the inter-electrode pitch between the first electrode 31 and the second electrode 32. The chip fuse 30 is installed across the first electrical connection portion 41 and the second electrical connection portion 51. Here, the first terminal fitting 40 and the second terminal fitting 50 are arranged such that the interval between the contact portion 41a of the first electrical connection portion 41 and the contact portion 51a of the second electrical connection portion 51 is matched with the inter-electrode pitch between the first electrode 31 and the second electrode 32. Therefore, the chip fuse 30 is installed across the contact portion 41a of the first electrical connection portion 41 and the contact portion 51a of the second electrical connection portion 51.

Further, the first terminal fitting 40 illustrated here is arranged such that the first electrical connection portion 41 and the conductor connection portion 42 are adjacent to each other in a facing arrangement direction of the contact portions 41a and 51a thereof. The second terminal fitting 50 illustrated here is arranged such that the second electrical connection portion 51 and the wiring connection portion 52 are adjacent to each other in the facing arrangement direction of the contact portions 41a and 51a thereof.

The fuse unit 20 includes a resin member 70 that holds the first terminal fitting 40 and the second terminal fitting 50 and maintains an interval between the first terminal fitting 40 and the second terminal fitting 50. The resin member 70 is made of an electrically insulating resin, and houses, for example, the first electrical connection portion 41, the second electrical connection portion 51, and the chip fuse 30. That is, the resin member 70 is provided with a housing chamber 70a that houses the first electrical connection portion 41, the second electrical connection portion 51, and the chip fuse 30.

The resin member 70 includes a plurality of housing members assembled and fixed to each other to form the housing chamber 70a inside. The plurality of housing members are formed of an electrically insulating material such as a synthetic resin. The plurality of housing members are molded as members separate from the first electrical connection portion 41, the second electrical connection portion 51, and the chip fuse 30, and surround the first electrical connection portion 41, the second electrical connection portion 51, and the chip fuse 30 to be housed in the housing chamber 70a.

Specifically, the resin member 70 illustrated here includes, as the plurality of housing members, a first housing member 70A and a second housing member 70B that sandwich the first electrical connection portion 41, the second electrical connection portion 51, and the chip fuse 30 between each other and house them in the housing chamber 70a.

The first housing member 70A is provided with an installation surface 71 on which the first electrical connection portion 41 and the second electrical connection portion 51 are placed. The chip fuse 30 is placed on the first electrical connection portion 41 and the second electrical connection portion 51 placed on the installation surface 71. For example, the first housing member 70A is molded as a base member for placing the first electrical connection portion 41 and the second electrical connection portion 51 on the installation surface 71. The first housing member 70A illustrated here is formed in a rectangular flat plate shape.

The second housing member 70B is molded as a cover member that covers the first electrical connection portion 41, the second electrical connection portion 51, and the chip fuse 30 at an assembly completion position with respect to the first housing member 70A as the base member.

The second housing member 70B has a lid portion 72 which is arranged to face the installation surface 71 of the first housing member 70A with the first electrical connection portion 41, the second electrical connection portion 51, and the chip fuse 30 interposed therebetween at the assembly completion position. The lid portion 72 illustrated here is formed in a rectangular flat plate shape, and is arranged parallel to the installation surface 71 of the first housing member 70A at the assembly completion position.

Further, the second housing member 70B has a pair of first side wall portions 73 that are suspended from the lid portion 72 and arranged to face each other with an interval therebetween in the facing arrangement direction of the contact portion 41a in the first electrical connection portion 41 and the contact portion 51a in the second electrical connection portion 51. The first side wall portion 73 illustrated here is formed in a rectangular flat plate shape, and a side portion at a distal end is brought into contact with the installation surface 71 of the first housing member 70A at the assembly completion position. However, a first cutout 73a for drawing out the conductor connection portion 42 side of the first electrical connection portion 41 to the outside of the housing chamber 70a is formed in the side portion at the distal end of the one first side wall portion 73. Further, a second cutout 73b for drawing out the wiring connection portion 52 side of the second electrical connection portion 51 to the outside of the housing chamber 70a is formed in the side portion of the distal end of the other first side wall portion 73.

Moreover, the second housing member 70B has a pair of second side wall portions 74 that are suspended from the lid portion 72 and arranged to face each other with an interval therebetween in a direction orthogonal to the facing arrangement direction of the lid portion 72 and the first housing member 70A and the facing arrangement direction of the contact portions 41a and 51a. The second side wall portion 74 illustrated here is formed in a rectangular flat plate shape, and a side portion at a distal end is brought into contact with the installation surface 71 of the first housing member 70A at the assembly completion position.

The second housing member 70B has an internal space surrounded by the lid portion 72, the pair of first side wall portions 73, and the pair of second side wall portions 74. In the resin member 70, when the first housing member 70A and the second housing member 70B are at the assembly completion position, the opening of the internal space of the second housing member 70B is closed by the first housing member 70A, and the internal space becomes the housing chamber 70a.

For example, in the resin member 70, the side portion at the distal end of the pair of first side wall portions 73 and the side portion at the distal end of the pair of second side wall portions 74 are fixed to the installation surface 71 of the first housing member 70A by thermal welding or the like at the assembly completion position.

Further, for example, it is desirable that the first housing member 70A and the second housing member 70B are formed and fixed in a shape in which a gap between the first housing member and the second housing member can be eliminated at the assembly completion position so that the housing chamber 70a becomes a sealed space at the assembly completion position. As a result, the fuse unit 20 can suppress the intrusion of liquid, dust, or the like into the housing chamber 70a, so that it is possible to suppress deterioration in quality or durability due to the intrusion of the liquid or the like.

Here, between the installation surface 71 of the first housing member 70A and the first electrical connection portion 41, a first positioning structure 75A for positioning the first electrical connection portion 41 with respect to the installation surface 71 is provided. A second positioning structure 75B for positioning the second electrical connection portion 51 with respect to the installation surface 71 is provided between the installation surface 71 of the first housing member 70A and the second electrical connection portion 51. In the first positioning structure 75A and the second positioning structure 75B, the first electrical connection portion 41 and the second electrical connection portion 51 are positioned by adjusting the interval between the contact portion 41a in the first electrical connection portion 41 and the contact portion 51a in the second electrical connection portion 51 to the inter-electrode pitch between the first electrode 31 and the second electrode 32.

The first positioning structure 75A includes a first protrusion 71a and a first recess 41b. The first protrusion 71a is formed on the first housing member 70A of the resin member 70. That is, the first protrusion 71a is formed to protrude from the installation surface 71 of the first housing member 70A. The first recess 41b is formed in the first electrical connection portion 41 of the first terminal fitting 40, and is provided with a size capable of fitting the first protrusion 71a. In the first positioning structure 75A illustrated here, the first protrusion 71a is formed in a columnar shape, and the first recess 41b is formed as a circular through hole. However, in the first positioning structure 75A, in order to prevent the rotation of the first terminal fitting 40 about the axis of the first protrusion 71a, for example, the first protrusion 71a may be formed in a prismatic shape, and the first recess 41b may be formed as a rectangular through hole.

A plurality of first protrusions 71a and a plurality of first recesses 41b are formed. The plurality of first protrusions 71a and the plurality of first recesses 41b are provided so as to be fitted to each other. For example, two first protrusions 71a are formed side by side along the width direction Y, and two first recesses 41b are formed side by side along the width direction Y. A formation interval between the first protrusion 71a and the first protrusion 71a is the same distance as a formation interval between the first recess 41b and the first recess 41b. The resin member 70 and the first terminal fitting 40 are joined by fitting the plurality of first protrusions 71a and the plurality of first recesses 41b, respectively. The number of the first protrusions 71a and the first recesses 41b installed may be three or more.

The resin member 70 and the first terminal fitting 40 are firmly joined by fitting the plurality of first protrusions 71a and the plurality of first recesses 41b, respectively. For example, bonding strength between the resin member 70 and the first terminal fitting 40 can be increased as compared with the case where one first protrusion 71a and one first recess 41b are fitted and bonded.

Further, in the resin member 70 and the first terminal fitting 40, since the plurality of first protrusions 71a and the plurality of first recesses 41b are respectively fitted, it is possible to suppress relative rotation of the resin member 70 and the first terminal fitting 40 about fitting positions of the first protrusions 71a and the first recesses 41b, and it is possible to stabilize the bonded state of the resin member 70 and the first terminal fitting 40.

In the resin member 70 and the first terminal fitting 40, the plurality of first protrusions 71a are formed side by side in the width direction Y, and the plurality of first recesses 41b are formed side by side in the width direction Y, so that the resin member 70 and the first terminal fitting 40 can be made compact, and the fuse unit 20 can be downsized. For example, if the plurality of first protrusions 71a and the plurality of first recesses 41b are formed side by side in the connection direction X, the resin member 70 and the first terminal fitting 40 are formed long in the connection direction X. On the other hand, in the fuse unit 20 according to the present embodiment, the plurality of first protrusions 71a and the plurality of first recesses 41b are formed side by side in the width direction Y, so that the resin member 70 and the first terminal fitting 40 can be made compact and small.

The second positioning structure 75B includes a second protrusion 71b and a second recess 51b. The second protrusion 71b is formed on the first housing member 70A of the resin member 70. That is, the second protrusion 71b is formed to protrude from the installation surface 71 of the first housing member 70A. The second recess 51b is formed in the second electrical connection portion 51 of the second terminal fitting 50, and is provided with a size capable of fitting the second protrusion 71b. In the second positioning structure 75B illustrated here, the second protrusion 71b is formed in a columnar shape, and the second recess 51b is formed as a circular through hole. However, in the second positioning structure 75B, in order to prevent the rotation of the second terminal fitting 50 about the axis of the second protrusion 71b, for example, the second protrusion 71b may be formed in a prismatic shape, and the second recess 51b may be formed as a rectangular through hole.

The first housing member 70A is a plate body extending in the connection direction X, and is formed to include a region from a first forming position where the first recess 41b of the first terminal fitting 40 is formed to a second forming position where the second recess 51b of the second terminal fitting 50 is formed. The first housing member 70A holds the first terminal fitting 40 and the second terminal fitting 50 by fitting the first protrusion 71a into the first recess 41b and fitting the second protrusion 71b into the second recess 51b, and maintains the distance between the first terminal fitting 40 and the second terminal fitting 50.

A plurality of second protrusions 71b and a plurality of second recesses 51b are formed. The plurality of second protrusions 71b and the plurality of second recesses 51b are provided so as to be fitted to each other. For example, two second protrusions 71b are formed side by side along the width direction Y, and two second recesses 51b are formed side by side along the width direction Y. A formation interval between the second protrusion 71b and the second protrusion 71b is the same distance as a formation interval between the second recess 51b and the second recess 51b. The resin member 70 and the second terminal fitting 50 are joined by fitting the plurality of second protrusions 71b and the plurality of second recesses 51b, respectively. The number of the second protrusions 71b and the second recesses 51b installed may be three or more.

The resin member 70 and the second terminal fitting 50 are firmly joined by fitting the plurality of second protrusions 71b and the plurality of second recesses 51b, respectively. For example, bonding strength between the resin member 70 and the second terminal fitting 50 can be increased as compared with the case where one second protrusion 71b and one second recess 51b are fitted and bonded.

Further, in the resin member 70 and the second terminal fitting 50, since the plurality of second protrusions 71b and the plurality of second recesses 51b are respectively fitted, it is possible to suppress relative rotation of the resin member 70 and the second terminal fitting 50 about fitting positions of the second protrusions 71b and the second recesses 51b, and it is possible to stabilize the bonded state of the resin member 70 and the second terminal fitting 50.

In the resin member 70 and the second terminal fitting 50, the plurality of second protrusions 71b are formed side by side in the width direction Y, and the plurality of second recesses 51b are formed side by side in the width direction Y, so that the resin member 70 and the second terminal fitting 50 can be made compact, and the fuse unit 20 can be downsized. For example, if the plurality of second protrusions 71b and the plurality of second recesses 51b are formed side by side in the connection direction X, the resin member 70 and the second terminal fitting 50 are formed long in the connection direction X. On the other hand, in the fuse unit 20 according to the present embodiment, the plurality of second protrusions 71b and the plurality of second recesses 51b are formed side by side in the width direction Y, so that the resin member 70 and the second terminal fitting 50 can be made compact and small.

For example, in the fuse unit 20, the first electrical connection portion 41 and the second electrical connection portion 51 are installed on the installation surface 71 of the first housing member 70A. In the first electrical connection portion 41 and the second electrical connection portion 51, the interval between the contact portions 41a and 51a is matched to the inter-electrode pitch between the first electrode 31 and the second electrode 32 by the first positioning structure 75A and the second positioning structure 75B. Therefore, in the fuse unit 20, by installing the chip fuse 30 in the contact portions 41a and 51a of the first electrical connection portion 41 and the second electrical connection portion 51, respectively, the first electrode 31 of the chip fuse 30 can be placed on the contact portion 41a of the first electrical connection portion 41, and the second electrode 32 of the chip fuse 30 can be placed on the contact portion 51a of the second electrical connection portion 51. In the fuse unit 20, the first electrode 31 and the contact portion 41a of the first electrical connection portion 41 is directly and electrically connected by laser welding, soldering, or the like, and the second electrode 32 and the contact portion 51a of the second electrical connection portion 51 is directly and electrically connected by laser welding, soldering, or the like.

Here, in the fuse unit 20, the first housing member 70A is a base member, and there is no wall portion or the like that covers the periphery of the first electrical connection portion 41, the second electrical connection portion 51, and the chip fuse 30 installed on the installation surface 71. Therefore, in the fuse unit 20, the laser irradiator and the soldering iron can be brought close to the first electrode 31 and the contact portion 41a of the first electrical connection portion 41 and to the second electrode 32 and the contact portion 51a of the second electrical connection portion 51 from various directions, and the laser light can be emitted from all directions between the first electrode 31 and the contact portion 41a and between the second electrode 32 and the contact portion 51a, or soldering can be performed therebetween from all directions by a soldering iron. Therefore, the fuse unit 20 can increase the degree of freedom in manufacturing when the first electrical connection portion 41, the second electrical connection portion 51, and the chip fuse 30 are directly and electrically connected.

Subsequently, in the fuse unit 20, the second housing member 70B is put on the first electrical connection portion 41, the second electrical connection portion 51, and the chip fuse 30, and the first housing member 70A and the second housing member 70B at the assembly completion position are fixed by thermal welding or the like. Here, it is assumed that the wiring component 60 is connected to the wiring connection portion 52 of the second terminal fitting 50 in advance.

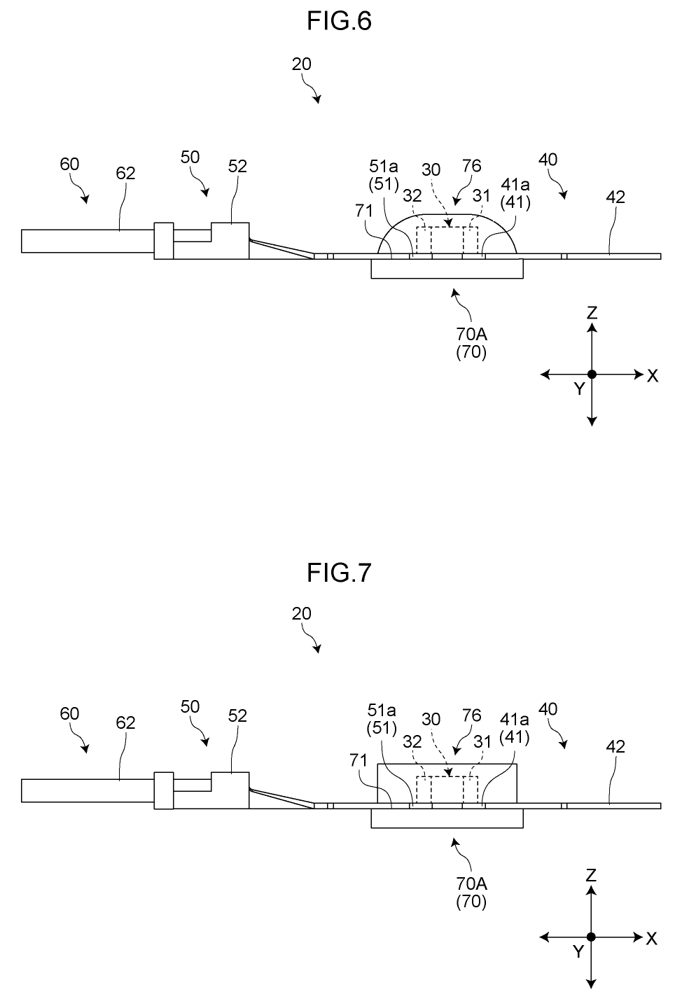

In the fuse unit 20, the first electrical connection portion 41, the second electrical connection portion 51, and the chip fuse 30 are exposed in the housing chamber 70a. Therefore, as illustrated in FIG. 6, the fuse unit 20 may include an electrically insulating sheath resin portion 76 enclosing the chip fuse 30, the first electrical connection portion 41, and the second electrical connection portion 51 in the housing chamber 70a. The sheath resin portion 76 encloses the chip fuse 30, the first electrical connection portion 41, and the second electrical connection portion 51 to suppress energization between the first electrical connection portion 41 and the second electrical connection portion 51. For example, even if dew condensation occurs in the housing chamber 70a, the sheath resin portion 76 can suppress a short circuit in the housing chamber 70a due to the dew condensation water. The sheath resin portion 76 can also function as a fixing member that fixes the first electrical connection portion 41, the second electrical connection portion 51, and the chip fuse 30 to the first housing member 70A in the housing chamber 70a by being fixed to the installation surface 71 of the first housing member 70A.

For example, the sheath resin portion 76 is a solidified material of a liquid resin material (so-called potting material) supplied by dropping or the like so as to wrap the chip fuse 30, the first electrical connection portion 41, and the second electrical connection portion 51. In this case, first, a liquid potting material is supplied to the chip fuse 30, the first electrical connection portion 41, and the second electrical connection portion 51 installed on the installation surface 71 of the first housing member 70A. Thereafter, according to the properties of the potting material, the potting material is irradiated with ultraviolet rays or heated to form the sheath resin portion 76 in which the potting material is cured. Since the sheath resin portion 76 undergoes such a manufacturing process, it is desirable to form the sheath resin portion using a liquid potting material having a viscosity that can be stopped on the installation surface 71 until curing so that the liquid potting material does not flow out from the installation surface 71 of the first housing member 70A as the base member before curing.

Here, in the case of the ultraviolet curable type potting material, it is necessary to bring the ultraviolet irradiator close to the liquid potting material. In the fuse unit 20, the first housing member 70A is a base member, and there is no wall portion or the like that covers the periphery of the supplied liquid potting material. Therefore, in the fuse unit 20, the ultraviolet irradiator can be brought close to the liquid potting material from various directions on the installation surface 71 of the first housing member 70A, and the ultraviolet ray can be irradiated from all directions toward the liquid potting material. Therefore, the fuse unit 20 can increase the degree of freedom in manufacturing when the sheath resin portion 76 is formed.

Further, for example, the sheath resin portion 76 may be a solidified material that is filled in the housing chamber 70a and encloses the chip fuse 30, the first electrical connection portion 41, and the second electrical connection portion 51. In this case, for example, a supply hole (not illustrated) for supplying a liquid resin material to the inside (housing chamber 70a) of the first housing member 70A and the second housing member 70B at the assembly completion position is provided in either one of the first housing member 70A and the second housing member 70B. Here, when there is no gap between the first housing member 70A and the second housing member 70B at the assembly completion position (in other words, if the airtightness of the housing chamber 70a is high), either one of the first housing member 70A and the second housing member 70B is provided with an air vent hole (not illustrated) for releasing the gas in the housing chamber 70a to the outside of the room during supply of the liquid resin material. In this case, a liquid resin material is supplied from the supply hole to the inside (housing chamber 70a) of the first housing member 70A and the second housing member 70B at the assembly completion position and filled, and the resin material is cured to form the sheath resin portion 76. When there is a gap between the first housing member 70A and the second housing member 70B at the assembly completion position (in other words, if the airtightness of the housing chamber 70a is low), or when there is a concern that the liquid resin material may flow out of the housing chamber 70a, for example, when a supply hole or an air vent hole has to be provided vertically downward, it is desirable to form the sheath resin portion 76 using a liquid resin material having a viscosity that can be stopped in the housing chamber 70a until curing.

In FIG. 1, the conductive module 1 includes an electrically insulating module resin portion 80 in which the fuse unit 20 is housed together with the connection conductor 10. The module resin portion 80 is provided with a housing chamber (hereinafter, referred to as a "conductor housing chamber") 80a that houses the connection conductor 10 and a housing chamber (hereinafter referred to as a "unit housing chamber") 80b that houses the fuse unit 20.

For example, the module resin portion 80 has a conductor housing chamber 80a for each of the connection conductors 10 connected to the respective electrode terminals BCb of the electrode terminal group BCc. On the other hand, the module resin portion 80 has the unit housing chamber 80b in which the fuse units 20 for the respective connection conductors 10 are collectively housed.

In the unit housing chamber 80b, the wiring component 60 (electric wire) of each fuse unit 20 is routed to the battery monitoring unit side. In each wiring component 60 (electric wire), the other end routed to the battery monitoring unit side is connected to a connector 65 (FIG. 1). Each wiring component 60 (electric wire) is indirectly and electrically connected to the battery monitoring unit via the connector 65.

When the wiring component 60 is a flat wiring member, the unit housing chamber 80b houses the wiring component 60 (flat wiring member) having the conductor portion 61 connected to the second terminal fitting 50 of each fuse unit 20 (not illustrated).

The module resin portion 80 includes a first housing member (hereinafter referred to as a "first module housing member") 80A and a second housing member (hereinafter referred to as a "second module housing member"; not illustrated) that are assembled and fixed to each other to form a plurality of conductor housing chambers 80a and unit housing chambers 80b therein. The first module housing member 80A and the second module housing member are formed of an electrically insulating material such as a synthetic resin.

The first module housing member 80A is provided with a space portion for forming the plurality of conductor housing chambers 80a and the unit housing chamber 80b at the assembly completion position with the second module housing member. The second module housing member is molded as a cover member that covers the opening of each space portion.

As described above, in the fuse unit 20 and the conductive module 1 of the present embodiment, the first terminal fitting 40 and the resin member 70 are joined by fitting the plurality of first recesses 41b and the plurality of first protrusions 71a, and the second terminal fitting 50 and the resin member 70 are joined by fitting the plurality of second recesses 51b and the plurality of second protrusions 71b, whereby the bonding strength of the first terminal fitting 40, the second terminal fitting 50, and the resin member 70 can be increased.

In the fuse unit 20 and the conductive module 1 of the present embodiment, the first terminal fitting 40 and the resin member 70 are joined by fitting the plurality of first recesses 41b and the plurality of first protrusions 71a, and the second terminal fitting 50 and the resin member 70 are joined by fitting the plurality of second recesses 51b and the plurality of second protrusions 71b, so that the first terminal fitting 40 and the resin member 70 can be prevented from relatively rotating about the first protrusions 71a, and the second terminal fitting 50 and the resin member 70 can be prevented from relatively rotating about the second protrusions 71b.

In the fuse unit 20 and the conductive module 1 according to the present embodiment, the first recess 41b and the first protrusion 71a are formed side by side along the width direction Y, and the second recess 51b and the second protrusion 71b are formed side by side along the width direction Y, so that the first terminal fitting 40 and the second terminal fitting 50 can be configured to be small with respect to the connection direction X, and the fuse unit 20 can be downsized.

The fuse unit 20 and the conductive module 1 according to the present embodiment include the first housing member 70A formed to include a region from the first forming position where the first recess 41b of the first terminal fitting 40 is formed to the second forming position where the second recess 51b of the second terminal fitting 50 is formed. Accordingly, for the fuse unit 20 and the conductive module 1 according to the present embodiment, the first housing member 70A holds the first terminal fitting 40 and the second terminal fitting 50 by fitting the first protrusion 71a into the first recess 41b and fitting the second protrusion 71b into the second recess 51b, and maintains the interval between the first terminal fitting 40 and the second terminal fitting 50.

In the fuse unit 20 and the conductive module 1 according to the present embodiment, since the resin member 70 has the sheath resin portion 76 provided so as to cover the chip fuse 30 and to be in contact with the first terminal fitting 40 and the second terminal fitting 50, the chip fuse 30 can be protected by the sheath resin portion 76.

The fuse unit and the conductive module according to the present invention are not limited to the above-described embodiments, and various modifications can be made within the scope described in the claims. The fuse unit 20 and the conductive module 1 according to the present embodiment may be configured by appropriately combining the components of the embodiments and the modifications described above.

For example, in the fuse unit 20 and the conductive module 1 according to the above-described embodiment, all or a part of the resin member 70 may be formed by resin molding. For example, as illustrated in FIG. 7, the sheath resin portion 76 covering the chip fuse 30 may be formed by resin molding. Specifically, the sheath resin portion 76 may be formed by insert molding an element as an insert, in which the first terminal fitting 40 and the second terminal fitting 50 are assembled to the first housing member 70A, and the chip fuse 30 is connected between the first terminal fitting 40 and the second terminal fitting 50. In addition, the portion of the sheath resin portion 76 and the first housing member 70A may be formed by insert molding an insert obtained by connecting the chip fuse 30 between the first terminal fitting 40 and the second terminal fitting 50. In this case, the resin-molded portion of the resin member 70 is formed to enter between the first recess 41b and the second recess 51b, and has the first protrusion 71a and the second protrusion 71b.

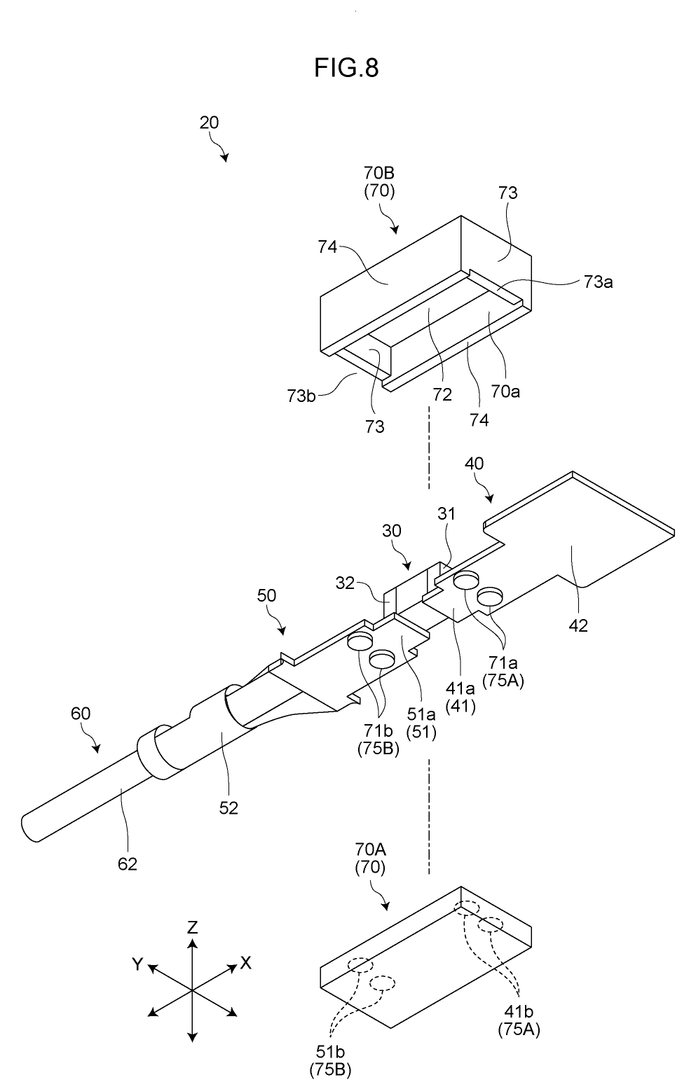

In the fuse unit 20 and the conductive module 1 according to the above-described embodiment, the first protrusion 71a and the second protrusion 71b are formed on the first housing member 70A, the first recess 41b is formed on the first terminal fitting 40, and the second recess 51b is formed on the second terminal fitting 50. However, the first recess 41b and the second recess 51b may be formed on the first housing member 70A. For example, as illustrated in FIG. 8, the first recess 41b and the second recess 51b may be formed on the surface of the first housing member 70A, the first protrusion 71a protruding toward the first housing member 70A may be formed on the first terminal fitting 40, and the second protrusion 71b protruding toward the first housing member 70A may be formed on the second terminal fitting 50. Even in such a fuse unit and conductive module, by providing a plurality of first recesses 41b, second recesses 51b, first protrusions 71a, and second protrusions 71b, similarly to the fuse unit 20 and conductive module 1 described above, the bonding strength between the first terminal fitting 40, the second terminal fitting 50, and the resin member 70 can be increased, the relative rotation between the first terminal fitting 40 and the resin member 70 can be suppressed, and the relative rotation between the second terminal fitting 50 and the resin member 70 can be suppressed.

According to the fuse unit and the conductive module of the present embodiment, the bonding strength between the resin member and the terminal fitting can be increased.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A fuse unit, comprising:
a chip fuse including a first electrode, a second electrode, and a fusible portion that is fused by overcurrent;
a first terminal fitting having a plate shape and being connected to a connection target and to the first electrode;
a second terminal fitting having a plate shape and connected to the second electrode; and
a resin member that holds the first terminal fitting and the second terminal fitting and maintains an interval between the first terminal fitting and the second terminal fitting, wherein
either of a plurality of recesses or a plurality of protrusions are formed on the first terminal fitting and the second terminal fitting,
the other of the plurality of recesses or the plurality of protrusions are formed on the resin member, and
the plurality of recesses and the plurality of protrusions are respectively fitted.

2. The fuse unit according to claim 1, wherein
the recess and the protrusion are formed side by side along a width direction intersecting a connection direction with the connection target.

3. The fuse unit according to claim 1, wherein
the resin member includes a first housing member formed as a plate body or a block body, which is provided in a connection direction with the connection target, and
the first housing member is formed to include a region from a first forming position where either of the plurality of recesses or the plurality of protrusions are formed on the first terminal fitting to a second forming position where either of the plurality of recesses or the plurality of protrusions are formed on the second terminal fitting, and the other of the plurality of recesses or the plurality of protrusions are formed thereon.

4. The fuse unit according to claim 2, wherein
the resin member includes a first housing member formed as a plate body or a block body, which is provided in a connection direction with the connection target, and
the first housing member is formed to include a region from a first forming position where either of the plurality of recesses or the plurality of protrusions are formed on the first terminal fitting to a second forming position where either of the plurality of recesses or the plurality of protrusions are formed on the second terminal fitting, and the other of the plurality of recesses or the plurality of protrusions are formed thereon.

5. The fuse unit according to claim 1, wherein
the resin member includes a sheath resin portion that is provided to cover the chip fuse and is to be in contact with the first terminal fitting and the second terminal fitting, the sheath resin portion being formed by curing a liquid or a fluid.

6. The fuse unit according to claim 2, wherein
the resin member includes a sheath resin portion that is provided to cover the chip fuse and is to be in contact with the first terminal fitting and the second terminal fitting, the sheath resin portion being formed by curing a liquid or a fluid.

7. A conductive module, comprising:
a connection conductor electrically connected to an electrode terminal of a battery cell constituting a battery module; and
a fuse unit that electrically connects the connection conductor to a battery monitoring unit that monitors a battery state of the battery cell, wherein
the fuse unit includes:
a chip fuse including a first electrode, a second electrode, and a fusible portion that is fused by overcurrent;
a first terminal fitting having a plate shape and being connected to the connection conductor and to the first electrode;
a second terminal fitting having a plate shape and connected to the second electrode and
a resin member that holds the first terminal fitting and the second terminal fitting and maintains an interval between the first terminal fitting and the second terminal fitting, wherein
either of a plurality of recesses or a plurality of protrusions are formed on the first terminal fitting and the second terminal fitting,
the other of the plurality of recesses or the plurality of protrusions are formed on the resin member, and
the plurality of recesses and the plurality of protrusions are respectively fitted.
